(19) United States
(12) Patent Application Publication
(10) Pub. No.: US 2008/0306759 A1
(43) Pub. Date: Dec. 11, 2008

(54) Patient workflow process messaging notification apparatus, system, and method

(76) Inventors: Hakan Mehmel Ilkin, Pittsburgh, PA (US); Zeyno Aygen, Bethesda, MD (US); William J. Tomer, Pittsburgh, PA (US)

Correspondence Address: K&L GATES LLP, 535 SMITHFIELD STREET, PITTSBURGH, PA, 15222, US

(21) Appl. No.: 11/704,795

(22) Filed: Feb. 9, 2007

(51) Int. Cl. G06Q 50/00; G08B 23/00; G06F 3/048

(52) U.S. Cl. 705/2; 340/573.1; 715/765

(57) ABSTRACT

A system and method to communicate workflow process information associated with a patient. A notification configuration message includes at least one notification rule is received. The notification rule includes conditional tests to determine whether to transmit a notification message, determine the medium for communicating the notification message, and determine a recipient of the notification message. Patient information including the state of the patient through a patient workflow process is received. The notification message including the patient information is transmitted in a communication medium in accordance with the at least one notification rule.

### BACKGROUND

Patients and resources in a “healthcare facility” such as a medical diagnostic and/or therapeutic unit within a hospital, operating room, stand-alone surgery center, clinic or any unit or department thereof may be tracked as a patient advances through a patient workflow process. In a healthcare facility there may be multiple diagnostic and/or therapeutic departments such as radiology, oncology, catheterization, emergency, and/or surgical. A patient receiving diagnostic or therapeutic treatment in any of these departments may undergo a patient workflow process. For example, in the surgery department, a patient may undergo a patient workflow process known as a perioperative process. Herein, the term “perioperative” refers to the three phases of surgery: (1) preoperative, (2) intraoperative, and (3) postoperative. During the perioperative process (which may include the anesthesia workflow process), those desiring progress information about the patient typically have only limited mechanisms to obtain the information: by inquiring the healthcare facility staff. However, it is difficult for healthcare facility staff to obtain that information. Staff members must monitor the patient using a combination of verbal communications via telephone calls, in-person conversations, and personal observations. Consequently, the staff can become embroiled in the task of chasing down information on patient progress, and delays in communication can translate directly to delays in patient care. This also may result in neglect of other duties. Herein, the term “staff” refers to doctors, surgeons, anesthesiologists, nurses, and any other person responsible at some level for providing patient care.

In addition, the staff also must contend with how changes in patient treatment schedules affect their workflow. Should there be a deviation from or change in the workflow process schedule of any patient, the healthcare facility staff must be aware of such changes in order to alter their activities accordingly. In such instances, the staff members are faced with the same information gathering difficulties. These difficulties can result in the staff falling further behind schedule and cause further delays in patient care.

The patient is often accompanied by one or more family members. These family members may wait in the waiting room, move to another area of the healthcare facility, or leave the healthcare facility altogether. While these family members could be contacted in a number of different manners using a variety of techniques, they may not all choose the same method. Therefore, notifying all family members may require use of many different communications media, such as telephone, electronic mail (email), short message service, or pagers. In addition, the patient family members may wish to receive notifications at different points (e.g., milestones) during the perioperative process, and may wish to receive different information in the messages they receive.

Thus, there is a need for a system which can receive and process information concerning the progress a patient is making through a patient workflow process. There is also a need for a system which can independently convey that information to the family of the patient and others wishing to be informed, so as to relieve healthcare facility staff of that burden. There is a need for the system to communicate using a variety of different methods and media, and there is a need to adapt to new communication or distribution media without excessive cost or burden. There is also a need for the system to be individually configurable to allow for customization according to the unique preferences of each user. There is a further need for a system which can inform staff of any changes in or deviations in the original treatment schedule of the patient so they can manage their workflow accordingly.

### SUMMARY

One embodiment includes a method of communicating workflow process information associated with a patient. A notification configuration message comprising at least one notification rule is received. The notification rule comprises conditional tests to determine whether to transmit a notification message, determine the medium for communicating the notification message, and determine a recipient of the notification message. Patient information comprising the state of the patient through a patient workflow process is received. The notification message comprising the patient information is transmitted in a communication medium in accordance with the at least one notification rule. In one embodiment, the workflow process information is associated with a perioperative workflow process in a surgical department. In other embodiments, the workflow process information may be associated with a radiology, oncology, catheterization, and/or emergency process in the respective departments of a healthcare facility.

### BRIEF DESCRIPTION OF THE DRAWINGS

FIG. 1 illustrates one embodiment of a patient workflow process notification system comprising a patient workflow management (PWM) system.

FIG. 2 illustrates one embodiment of a perioperative notification system.

FIG. 3 is a diagram of one embodiment of the notification engine of the PWM system shown in FIG. 1.

FIG. 4A is a diagram illustrating the stages of one embodiment of a perioperative workflow process for an ambulatory patient.

FIG. 4B is a diagram illustrating the stages of one embodiment of a perioperative workflow process for an inpatient.

FIG. 5 is an example of a notification registration screen displayed by one embodiment of the notification graphical user interface (GUI), which presents configurable options to a user.

FIG. 6 is an example of one embodiment of a notification template screen displayed by one embodiment of the notification GUI.

FIG. 7 is an example notification composer screen displayed by one embodiment of the notification GUI.

FIG. 8 is an example of a login screen as displayed by one embodiment of the notification GUI.

FIG. 9 is an example of notification messages as displayed by one embodiment of the notification GUI.

FIG. 10 is a diagram illustrating a logic of a production rule according to a perioperative notification systems comprising a PWM system described herein

### DESCRIPTION

The various embodiments described herein are directed generally to apparatuses, systems, and methods for distributing information associated with a patient workflow process in a healthcare facility. As previously discussed, a healthcare facility may be a hospital, clinic, stand-alone surgery center, among others, that provides medical diagnostic and/or therapeutic services for patients. A healthcare facility may comprise multiple diagnostic and/or therapeutic departments such as radiology, oncology, catheterization, emergency, and/or surgical. A patient receiving medical diagnostic and/or therapeutic treatments in any of these departments may undergo a patient workflow process. Accordingly, various embodiments described herein are directed to tracking and/or distributing information associated with a patient as the patient progresses or advances through such a patient workflow process. For example, in reference to a surgery department of a healthcare facility, a patient may undergo a patient workflow process known as a perioperative workflow process. Herein, the term “perioperative” refers to the three phases of surgery: (1) preoperative, (2) intraoperative, and (3) postoperative.

In addition, various embodiments described herein are directed to apparatuses, systems, and methods for distributing messages concerning the progress of a patient through a patient workflow process to people having an association with, interest in, caring for, or relationship with the patient. For convenience and clarity any person associated with, interested in, caring for, or having a relationship with the patient may be referred to herein as a “stakeholder”. For example, the term stakeholder may refer to the patient family members and/or the hospital staff. It is to be understood, however, that as used herein the term “family” is intended to encompass more than just the traditional family members of the patient and comprises friends, relatives, guardians or any person designated by the patient or legal authority having an association with, any interest in, or any relationship with the patient. Furthermore, as used herein, the term “staff” refers to doctors, surgeons, anesthesiologists, nurses, and any other person responsible at some level for providing patient care. The embodiments, however, are not limited in this context.

Accordingly, when the patient workflow process information (e.g., patient data) is received, the information may be distributed to the stakeholders, e.g., the staff and/or the patient family members as described in various embodiments herein. In accordance with these embodiments, as the patient progresses through the patient workflow process information associated therewith is collected and processed. Such information can be collected through one or more methods. For example, the information may be entered manually through a workstation coupled to a computer system by a local area network. In addition, the information may be entered automatically into the system by one or more techniques, such as reading the location of a patient from a patient locator badge and a real-time location system. One such real-time location system may comprise radio frequency identification (RFID) technology wherein the patient is provided with an RFID tag that can be read and monitored by an RFID tracking system, for example. The embodiments, however, are not limited in this context.

A computer system may be implemented as a server to receive the patient workflow process information or data from any source. The computer system may have knowledge of a proposed course of diagnostic and/or therapeutic treatment for the patient in any department of the healthcare facility, as well as the steps and processes which are implicated by that course of treatment. The computer system may comprise a rule based engine which makes decisions (e.g., determinations) regarding submission of notification messages, the recipient of the messages, and the communications medium for the messages.

A process in accordance with various embodiments may comprise one or more computer systems receiving user input through a graphical user interface (GUI). This user interface may be a program which is executed on a workstation coupled to the computer system through a network, such as, for example, a local area network (LAN), available to the staff and/or to the family members. The user interface also may be executed on a kiosk computer that is accessible to the user, such as the patient family members and/or the staff. The user interface may be configured to receive data from either the staff or the family members which the system will use to determine which events during the patient workflow process may trigger a notification. These events may be referred to herein as patient milestones or simply as milestones. In addition, the data entered by the user may be used to determine to whom notifications are sent and in what medium.

Additional embodiments may comprise apparatuses, systems, and methods for generating the notification messages and transmitting the messages via a variety of communications media. The system comprises the necessary hardware and software components to send notifications through a variety of different communications media. For example, the system may transmit the notification messages by telephone, pager, short message service (SMS), multi-media message service (MMS) or email. Any form of computer or telecommunication mechanism and/or protocol may be employed for communication without limitation.

The notification system advances the distribution of information concerning the progress of a patient in a patient workflow process. The system may be adapted and configured to notify a wide scope of parties comprising all stakeholders. In one embodiment, the notification system creates a generic messaging interface where diverse stakeholders may be treated in a unified manner. The notification system also provides multiple delivery methods along with a framework to seamlessly integrate the delivery options. The notification system also provides automated message distribution. The messages may be triggered based on predetermined milestones or other events such as time stamps, delays, unmet milestones, or schedule updates, among others. In one embodiment, the notification system may be implemented as an on-demand messaging system. In such an on-demand messaging system, users may obtain information concerning the patient at any time regardless of the occurrence of any predetermined specified events.

The embodiments described herein provide an advance over conventional systems and methods for tracking patient status through a patient workflow process. One advantage may include, for example, automatically distributing information concerning the patient status by analyzing information such as the proposed course of treatment for the patient, as well as information regarding a particular diagnostic and/or therapeutic procedure. The notification system may be configured to distribute information to the stakeholders (or end-users) in accordance with pre-determined customizable criteria. The system may provide additional advantages such as making the patient status information available immediately or substantially in real-time to the staff and the family members. Making the information available immediately relieves the staff of burdensome information gathering duties, increases staff response time, and reduces patient care delays. Yet another advantage of the system is automatically communicating notification messages to the patient family members and the staff by a variety of communications media based on one or more preferences selected by the family members or the staff.

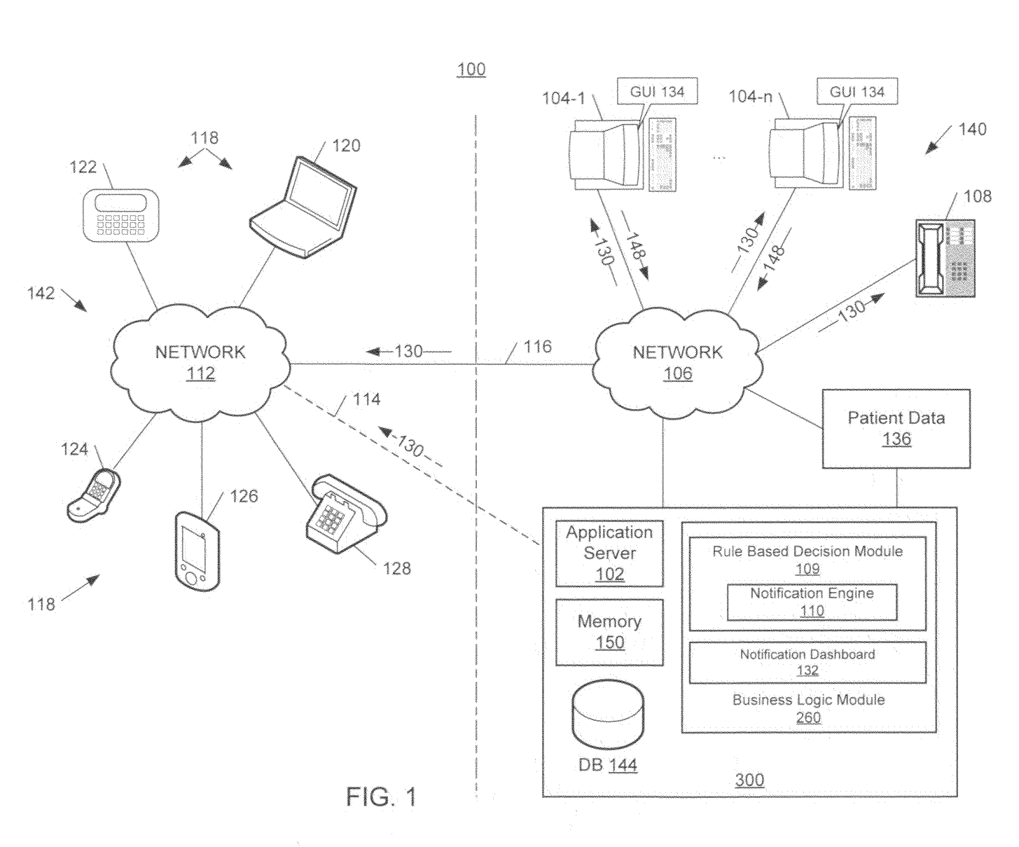

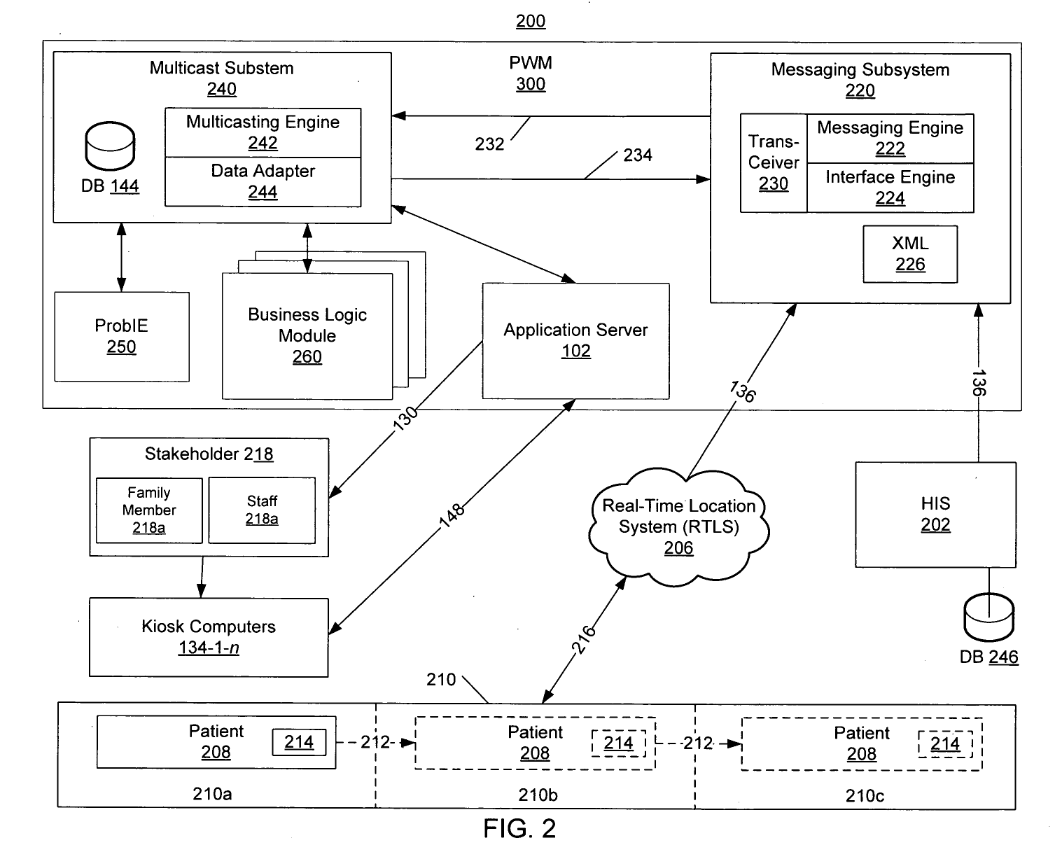

FIG. 1 illustrates one embodiment of a patient workflow process notification system 100 comprising a patient workflow management (PWM) system 300. The PWM system 300 may be adapted and configured to receive patient workflow process information or data 136 (“patient information” hereinafter) from a variety of sources. The patient information 136 may be received from a hospital information system 202 (HIS), a real-time location system 206 (RTLS) (FIG. 2), which could be a RFID tracking system, for example. In one implementation, the patient information 136 may be provided substantially on a real-time basis and may be stored in a database 144. In general the patient information 136 comprises the state of the patient through the patient workflow process. As previously discussed, the patient workflow process refers to the progress of a patient in any healthcare facility diagnostic and/or therapeutic process in any one of a radiology, oncology, catheterization, emergency, and/or surgical department. The patient information 136 refers to any information associated with these processes. A patient receiving medical diagnostic and/or therapeutic treatments in any of these departments may undergo a patient workflow process. In one embodiment, the content of the patient information 136 is also configurable. For example, the content of the patient information 136 can be configured to include/exclude: (1) Patient Name; (2) Care Provider; (3) Patient Location; (4) Healthcare Facility Site; (5) Location Group; (6) Case Information; (7) Clinical Information; (8) Event Information; and/or (9) Event Time. The patient information 136 may comprise the status of the patient, the condition of the patient, and/or the progress of the patient through a patient workflow process (described in more detail below in the context of a perioperative workflow). The PWM system 300 comprises an application server 102 coupled to one or more computers 104-1-n, where n is any positive integer. The computers 104-1-n may comprise special single function computers, workstations, large screen displays, and kiosks, for example, and any other message notification communication devices and/or media. The computers 104-1-n may comprise a display device, such as a liquid crystal display (LCD), plasma, thin film transistor (TFT), or cathode ray tube (CRT) monitor, a device for user input, such as a keyboard or mouse, a processor, an application component, and memory for receiving and processing entered information. The computers 104-1-n may be implemented as kiosks and may be made available to patient family members at various locations throughout a healthcare facility.

The PWM system 300 may be coupled to the computers 104-1-n over a first network 106. The first network 106 may be internal to the healthcare facility, such as a local area network (LAN), PBX system, and the like. The network 106 also may comprise internal networks such as the HIS 202, the RTLS 206. The PWM system 300 also may be coupled to a telephone system 108 either directly or via the first network 106. The PWM system 300 may comprise a rule based decision module 109. The rule based decision module 109 may comprise a notification engine 110. The rule based decision module 109 and the notification engine 110 are examples of instances of a business logic module 260 (FIG. 2), which may comprise multiple algorithms and data transformers for implementing the rule based decisions logic for transmitting a notification message.

The PWM system 300 may be coupled to a second network 112 by way of a connection 114. The PWM system 300 also may be coupled to the second network 112 by way of the first network 106 over a connection 116, for example. The PWM system 300 can support virtually any computer or telecommunication mechanisms for communication. In one embodiment, the PWM system 300 may be implemented to use communication mechanisms that may be currently common within healthcare facility and consumer domains. Accordingly, the second network 112 may provide the PWM system 300 with access to a variety of communications devices 118. The communications devices 118 may comprise, for example, a laptop or other computer 120, a pager 122, a cell phone or smart phone 124, a personal digital assistant 126 (PDA), or a landline telephone 128. The PWM system 300 can transmit notification messages 130 to these communications devices 118 using a variety of communication media. Accordingly, the communications devices 118 can receive the notification messages 130 in a variety of communication media such, for example, email, short messaging service (SMS), multimedia messaging service (MM), paging signals, cellular or plain old telephone analog signals (e.g., landline and/or wireless telephones), and the like. Although the first and second networks 108, 112, respectively, are shown as separate networks, those skilled in the art will appreciate that the networks 108, 112 may be combined as a single network or may be expanded to multiple networks without limitation.

The patient workflow process notification system 100 may comprise or support a method by which a stakeholder (e.g., patient family member or healthcare staff) may be notified of patient status in accordance with pre-selected preferences. As used herein, the status of a patient may comprise the condition of the patient as well as the progress of the patient through the patient workflow process. The patient workflow process notification system 100 tracks resources within the healthcare facility, such as, for example, a healthcare facility, operating room (OR), or a stand-alone surgery center, oncology, radiology, catheterization, emergency, and/or surgical (e.g., the operating room [OR], among other departments. By tracking patients and resources and having knowledge of specific predetermined milestones associated with the patient, software modules executed by the application server 102 may be configured to store real-time patient information 136 about the status of the patient in the database 144 and to generate the messages 130 in accordance with the patient information 136. Based on the predetermined milestones (e.g., surgery begins, patient enters post-operative room, patient gets discharged, may be considered milestones in a perioperative workflow process, among others) the patient workflow process notification system 100 may facilitate improved communication between the stakeholders through an automated distribution system. This information in the form of messages 130 may be transferred to the stakeholders using various communications media and various communications devices 118.

Information may be displayed on a waiting room kiosk computer 104-1-n by way of a notification GUI 134. The notification GUI 134 computer interface presents the user with a number of configurable options. For example, the interface will allow users to indicate the specific milestones during the patient workflow process at which they wish to be notified. When a patient enters a department in a healthcare facility such as radiology, oncology, catheterization, emergency, and/or surgical, such as, for example, an OR or surgery center, the patient workflow process notification system 100 may notify any staff members that are needed but are not yet present. Through message notification, staff related delays may be minimized during the patient diagnostic and/or therapeutic treatment.

The rule based decision module 109 may be employed to trigger a notification in the form of a message 130 in accordance with a predefined and predetermined set of rules and/or criteria in the form of custom notification rules that are selected by a stakeholder. The custom notification rules information may be transmitted from the kiosk computer 104-1-n to the PWM system 300 in the form of a notification configuration message 148. The notification configuration message 148 may comprise the selected notification mechanism, message format, notification rules, and/or criteria for receiving the message 130. For example, the message 130 may be triggered for patient-care stages that meet previously defined conditional criteria (e.g., at the time a specific milestone is reached in the patient workflow process). The rule based decision module 109 determines whether the message 130 should be transmitted and if so, the content of the message 130, the communication (e.g., distribution) medium for the message 130 and to whom the message 130 is to be transmitted. In one embodiment, the rule based decision module 109 may encapsulate a rule based engine to: (1) enable logic and data de-coupling; (2) implement an event model to enable the notification engine 110 to listen and execute code based on the occurrence of certain events; (3) use forward chaining (i.e., modeling the notification rules after production rules); and (4) enable runtime addition and removal of rules.

The PWM system 300 may comprise a notification dashboard module 132, which is one example of one instance of a business logic module 260 (FIG. 2). The notification dashboard module 132 may display a notification GUI 134 on the computers 104-1-n to allow the end users of the patient workflow process notification system 100 (e.g., the stakeholders and/or family members) to configure and manage the notification engine 110 in accordance with certain predetermined preferences. The end user may author or create one or more message notification rules through the use of pre-defined “Notification Templates”. These custom notification rules may be retransmitted to the PWM system 300 in the notification configuration message 148. The notification dashboard module 132 may: (1) create and modify notification templates; (2) classify/tag notification templates; (3) configure notification logging settings; (4) browse and search persisted notification templates; and (5) instantiate from/test a notification template. The notification template may be created or modified in accordance with the: (1) delivery or communication media (e.g., email, SMS, MMS, paging, telephone, kiosk); (2) content, including data elements from cases/patient/events data-sources+free text+attachments; (3) delivery schedule ((no schedule: event-based, on demand), scheduled to be sent (periodically, one time)); (4) conditional criteria (mapping to rules-base); (5) recipients/CC options; and (6) activation status (active/inactive).

A distribution interface component may provide a variety of delivery or distribution methods (e.g., communications devices 118, telephone 108, kiosks 104-1-n) to the notification engine 110 with the flexibility of easily interchanging the delivery method without directly affecting the clients at the receiving end. The distribution interface component may be configured to implement late binding allowing the distribution service to instantiate any business object encapsulating a delivery strategy (e.g., email, SMS, MMS, pager, telephone, kiosk) without requiring code changes at the service level in the application server 102. Hence, the distribution interface component not only abstracts the “distribution strategy” and makes it possible to cater to a variety of third party telecommunication devices 118 but also allows for the dynamic adoption of these technologies.

In addition to the standard notification mechanisms previously discussed, the patient workflow process notification system 100 also may provide a web interface to show a known schedule for each patient. The web interface may be accessed on any computer system or device capable of accessing and viewing web pages. For example, it can be accessed on a personal computer equipped with an internet browser, such as Microsoft& Internet Explorer, for example. This interface allows the family members and the staff to use a computer or portable wireless device or any of the communication devices 118 that are web enabled to actively view the patient information 136, such as schedule, any time they wish, rather than receiving only notifications of completed milestones. The web interface may be provided to display a known schedule for each of the stakeholders 218. The stakeholders 218 may be referred to herein as users or end users, without limitation thereto, and may be referred to as recipients to receive notification messages 130, without limitation thereto. The web interface also may be accessed via any of the communication devices such as the laptop 120, the smartphone 124, the PDA 126, and/or the computers 104-1-n comprising a web browser, for example. In one embodiment, the web interface feature enables the stakeholders 218 to use a portable wireless device, e.g., the laptop 120, the smartphone 124, or the PDA 126, to actively view their schedule instead of receiving passive notification messages 130.

The PWM system 300 knows the intended diagnostic and/or therapeutic treatment flow of a patient through the patient workflow process and the location of patient within that process. For the purposes of the following description, this knowledge may be assumed to be known or may be obtained by the PWM system 300 on a real-time basis. The PWM system 300 employs an active form of communication to make this information available. In one embodiment, the PWM system 300 enables the active form of communication by formatting the message 130 for the distributed information and allowing the family members to be alerted or receive the message 130 “on-demand”.

The PWM system 300 may be integrated or operate in conjunction with other systems for tracking patients throughout the patient workflow process including communicating with external systems 142, communicating real-time data within internal systems 140, and incorporating a repository of events that are structured around a configurable set of predictive criteria (variables). Herein, the term internal systems 140 is used to refer to communication and processing systems that may pertain to a healthcare facility regardless of whether these systems are present in the same location. And the term external systems 142 is used to refer to communication and processing systems that are not specific to the healthcare facility even if they may be located or accessible within the healthcare facility.

FIG. 2 illustrates one embodiment of a perioperative notification system 200. The perioperative notification system 200 may be associated with the surgical process in a surgical department of healthcare facility. The perioperative notification system 200 is one embodiment of the patient workflow process notification system 100 illustrated in FIG. 1 that is directed specifically to the perioperative process. In the illustrated embodiment, the perioperative notification system 200 is integrated with the PWM system 300, the HIS 202, and the RTLS 206. Although the perioperative notification system 200 is described as an embodiment of the patient workflow process notification system 100, other embodiments of the patient workflow process notification system 100, such as any patient workflow processes associated with any healthcare facility diagnostic and/or therapeutic process in a radiology, oncology, catheterization, and/or emergency department, is intended to fall within the scope of the claimed invention.

In one embodiment, the RTLS 206 may be employed to track a patient 208 throughout a perioperative workflow process 210 using RTLS tags 214 located on the patient 208 or in proximity thereto or a locator badge dispensed to the patient 208 at check-in time. The locator badge may comprise the RTLS tag 214. The locator badge may interact with the RTLS 206. Herein, tracking the patient 208 throughout the perioperative workflow process 210 may include tracking the patient through a preoperative workflow process 211a, an intraoperative workflow process 211b, and/or a postoperative workflow process 211c. The RTLS 206 captures real-time patient location data 216 and provides that data to the PWM system 300 to determine when the patient 208 transitions 212 from one location to another or from one process to another (211a→211b→211c). The location data 216 is associated with events to determine the location of the patient 208 in the perioperative workflow process 210 (or anesthesia pathways). Consequently, the gathered real-time location data 216 is provided to the PWM system 300 in the form of the patient information 136, which may be received by the PWM system 300 from the HIS 202 and/or the RTLS 206.

The PWM system 300 sends messages 130 to the stakeholders 218 based on the patient information 136 and the notification configuration message 148 submitted to the PWM system 300 by the stakeholders 218 (e.g., patient family members 218a and healthcare facility staff 218b). Herein, the patient family member stakeholders are referred to as family members 218a and the healthcare facility staff stakeholders are referred to as staff 218b. As previously discussed, the stakeholders 218 may receive the messages 130 in accordance with preferences they entered in the computers 104-1-n via the notification GUI 134. In a similar manner, the stakeholders 218 also may select the content of the message 130 among others predetermined criteria via the notification GUI 134. In one embodiment, the PWM system 300 provides real-time visualization capabilities for the OR managers to make timely decisions regarding resource usage across multiple facilities.

The PWM system 300 receives and processes the real-time patient location data 216 received from RTLS 206 tags 214 dispensed to the individual patients 208 in the form of patient information 136. By processing the real-time patient information 136 comprising the location data 216 received from the RTLS tags 214, the PWM system 300 can determine when the patient 208 transitions 212 from one location to another within the healthcare facility during the perioperative workflow process 210. The real-time location data 216 from the RTLS 206 comprises information related the transitions 212 or movements of the patient 208 from one location to another during the perioperative workflow process 210 within a healthcare facility. The PWM system 300 may subsequently associate the real-time located data 216 with information related to the intended perioperative treatment for the patient 208 to determine the location of the patient 208 in the perioperative workflow process 210. This information may be stored and processed by the PWM system 300 to transmit the messages 130 to the stakeholders 218 concerning the status and/or progress of the patient 208 in the perioperative workflow 210 process.

The time the patient 208 arrives at a healthcare facility for a surgical procedure is either scheduled before the arrival or, in emergency cases, upon the arrival. When the patient 208 is scheduled, information about the patient 208, the care provider, and the procedure are determined by the staff 218b. This patient information, along with the proposed start time and duration of the scheduled procedure are entered into a patient data database 246. The database 246 may be present either in the HIS 202, or in a similar system that stores and processes patient information, such as the scheduled surgical procedure and duration time of the procedure.

The PWM system 300 also may contain a messaging subsystem 220. The messaging subsystem 220 may comprise a messaging engine 222 to provide an extensible, configurable framework for communicating with the internal 140 or the external 142 systems (FIG. 1). The messaging engine 222 may comprise an interface engine 224, XML streams 226, etc. Communication may be handled by one or more “transceivers” 230 that transmit messaging data 232 from the messaging engine 222 to the PWM system 300 and receive and provide messaging data 234 from the PWM system 300 to the messaging engine 222. The transceivers 230 convert outgoing internal data 232 into an external protocol specific for the purpose of each of the transceivers 230. Several transceivers 230 may be distributed throughout the messaging subsystem 220. The transceivers 230 may plug into the framework of the PWM system 300.

The PWM system 300 may contain a multicast subsystem 240 coupled to the application server 102. The multicast subsystem 240 may comprise a multicast engine 242 to provide an extensible, configurable framework for real-time data communication among any of the communication components or elements of the internal system 140 (FIG. 1). The architecture, however, also may provide external applications to plug into the multicast subsystem 240. The architecture may be implemented as a publish/subscribe model which also enables querying. Because the multicast subsystem 240 is responsible for persisting published data, as well as querying persisted data, a portion of its architecture may lie in one or more “data adapters” 244 which plug into the multicast engine 242 in a configurable fashion to facilitate persistence and retrieval of data to the one or more databases 144 (e.g., SQL databases), etc. The data adapters 244 may be provided to operate in conjunction with the multicast subsystem 240 to provide default persistence and retrieve all data supported for communication via the multicasting engine 242. The architecture may provide for the use of custom data adapters 244 to perform custom persistence and/or retrieval functionality. The multicast subsystem 240 may be coupled to a business logic module 260. Multiple instances of the business logic module 260 may provide functionality such as the rule based decision module 109, the notification engine 110, the notification dashboard 132, etc.

The PWM system 300 may contain a probabilistic interference engine (ProbIE) module 250. In one embodiment, the ProbIE module 250 may be part of the business logic algorithms data transformers module 260. The duration specific information of the message 130 may be incorporated through the ProbIE module 250. The ProbIE module 250 may be built-in to the PWM system 300 and provides duration estimations based on real-time contextual information. The ProbIE module 250 provides duration estimation incorporating a repository of events that are structured around a configurable set of predictive criteria (variables). These repositories may be implemented as model instances that evolve in time, i.e., the models may be re-structured when new event information is introduced to the PWM system 300. The ProbIE module 250 provides a query interface for retrieving estimated durations. The queries may contain incomplete (i.e., partially matching) criteria defining the event context for the interval of interest. When there is no exact match between the predictive criteria indexing events in the repository and the real-time criteria, the ProbIE module 250 will return the estimate for the best possible match along with an indicator that represents the “likelihood” for the estimation. The PWM system 300 also may employ the ProbIE module 250 to provide the staff 218b with estimated duration information that is specific to the procedure and the staff 218b performing the procedure.

The following description of the PWM system 300 functionality is with respect to the stakeholders 218 grouped under the “Patient Family” 218a category. The patient 208 is often accompanied by one or more family members 218a. These family members 218a may wait in the waiting room, move to another area of the healthcare facility (e.g., a cafeteria) or leave altogether. When the patient 208 arrives at the healthcare facility for a surgical procedure, the patient 208 is either scheduled a priori to their arrival or will be scheduled upon their arrival (e.g., emergency cases). At the time of scheduling, the information pertaining to the patient 208, the healthcare provider, and the procedures are persisted along with the projected start times. These reservations may be processed by the HIS 202.

When the patient 208 signs into the healthcare facility, they receive a badge (which may comprise an RTLS tag 214) that allows them to be recognized by the RTLS 206. The RTLS 206 tracks the patients through the perioperative workflow process 210. In a broader sense, the RTLs 206 may be adapted to track the patient 208 throughout any patient workflow processes. During the sign-in, the patient family members 218a may select how they wish to be notified of the patient 208 progress via the notification GUI 134. The family members 218a also may be able to indicate the specific milestones at which they wish to be notified.

The family members 218a may receive messages 130 concerning the status or progress of the patient 208 in a variety of communication methods throughout the patient workflow process notification system 100 and/or the perioperative notification system 200 via the PWM system 300. The default notification method is via the kiosk computers 104-1-n. Thus, the family members 218a may wish to disable this feature if they are not interested in receiving the notification via the kiosk computers 104-1-n.

When the patient 208 signs into the healthcare facility, each of the patient family members 218a may enter information that comprises their preferred notification method and corresponding contact information (e.g., email, cell phone number, etc.) for each of the selected notification methods into the kiosk computers 104-1-n via the notification GUI 134. For example, the patient family member 218a may provide the cell phone number or email address if an SMS or MMS message format was selected. The patient family member 218a may enter multiple message notification formats or methods for each patient 208. Once the contact information is entered, a test message 130 may be generated. Accordingly, the PWM system 300 will transmit the test message 130 through the appropriate notification mechanism selected by the patient family member 218a in a relatively short time. This information may be stored in the database 144 coupled to the computers 104-1-n within the patient workflow process notification system 100 and/or the perioperative notification system 200.

In addition to the contact information, the patient family member 218a may indicate if they are providing transportation for the patient 208 and whether they will be within the healthcare facility during the procedure. If the patient 208 is receiving treatment during an inpatient stay then the transportation option may not be available and may default to the healthcare facility staff 218b.

Furthermore, the patient family member 218a may indicate that they wish to be notified when a milestone is met during the perioperative workflow process 210. The patient family members 218a also may select not to be notified until certain milestones are met. The PWM system 300 may be configured to track all milestones.

The family member 218a may select notification based on meeting certain perioperative workflow process 210 milestones. Notification messages 130 may be transmitted after certain milestones are met or at every stage of the perioperative workflow process 210. TABLE 1 provides a list of example milestones during the perioperative workflow process 210 that may be selected by the family member 218a. The choice of milestones may differ across procedures and health care facilities.

TABLE 1
Patient Milestones

| | |
|---|---|
| 1. | Patient Signed in |
| 2. | Patient Ready for transport |
| 3. | Patient Sent for |
| 4. | Patient Available |
| 5. | Patient in Pre-Op |
| 6. | Anesthesia interview started |
| 7. | Anesthesia interview completed |
| 8. | Anesthesia started |
| 9. | Patient in procedure room |
| 10. | Physician in room |
| 11. | Procedure begins |
| 12. | Procedure ends |
| 13. | Patient out of procedure room |
| 14. | Patient in post-anesthesia care unit (PACU) |
| 15. | Anesthesia finished |
| 16. | Patient moved to Post-Op |
| 17. | Patient family interview |
| 18. | Patient ready for discharge |

The milestones listed in TABLE 1 are provided merely as an example of what the patient family member 218a may select from. These milestones may differ based on the procedures and the healthcare facility and, therefore, they are not exhaustive examples of milestones. Therefore, the embodiments discussed herein are not limited in this context.

The kiosk computers 104-1-n may be configured to display all the messages 130 selected by the patient family members 218a and may display a login screen as a default. To login, a user, e.g., the patient family member 218a, may type a unique code for the patient 208 for whom they wish to inquire. An example of one embodiment of a login screen 800 is shown in FIG. 8. The computer kiosk 104-1-n will also provide information describing which messages 130 were sent via alternate notification mechanisms. The kiosk computer 104-1-n then displays a list of all the messages 130 sent while the patient 208 progresses through the perioperative workflow process 210 including any new messages that have been generated since the last user login. It also may indicate which of the messages 130 were sent via alternate notification mechanisms.

In one embodiment, the message 130 may comprise more than just a generic announcement that a milestone has been reached. The message 130 also may comprise detailed and personalized information pertaining to the treatment received by the patient 208 in the preoperative area 211a, intraoperative area 211b, or postoperative area 211c. For example, when the patient 208 enters the post-operative area 211c, the family member 218a may receive the following telephonic message 130: “Hello, this is the Surgical Unit within Healthcare facility XXXXX. We are calling to inform you that the patient, _patient id_, has entered the post operative unit. The typical stay in post-op for a patient receiving this procedure is _NN_minutes. Thank you very much.” Additional data elements contained in specific messages 130, such as duration specific information, may be obtained by querying various components of the patient workflow notification system 100 and/or the perioperative notification system 200.

The following description of the PWM system 300 functionality is with respect to the stakeholders 218 grouped under the “Healthcare Staff” 218b (staff) category. The PWM system 300 also assists the staff 218b during the procedure. The staff 218b has an interest in receiving notifications regarding the progress of the patient 208. This interest, however, may be limited only to activities that apply to the needed participation of the staff 218b.

The perioperative workflow process 210 involves interaction between the patient 208 and the staff 218b. Although, the interaction often may be limited, the patient 208 cannot proceed through the perioperative process 210 without these interactions. Accordingly, the PWM system 300 notifies the staff 218b in preparation for their participation in any diagnostic and/or therapeutic procedure scheduled for the patient 208. For example, the surgeon, anesthesiologist, and other resources or staff 218b are scheduled via the HIS 202 prior to the patient 208 entering the intraoperative area 211b to undergo a surgical procedure. With this knowledge, the PWM system 300 may contact the staff 218b in preparation for their participation in the surgical procedure. For example, consider an anesthesiologist who is scheduled to administer anesthesia for the patient 208. This anesthesiologist may be notified by a message 130 from the PWM system 300 that the patient 208 has had their anesthesia assessment and is ready for the administration of the anesthesia.

With regard to the staff 218b notifications, the PWM system 300 may be configured to originate the messages 130 to the staff 218b concerning the status of the patient 208 through a procedure, but only to the extent that the messages 130 relate to their needed participation. To provide this functionality, the PWM system 300 may employ the rule based module 108, and the patient information 136 it receives from the HIS 202 and the perioperative workflow process 210. The staff 218b, in the same manner as the patient family member 218a previously discussed, can enter information to create rules for the staff notifications. This information can be entered through another instance of the notification GUI 134 running on a staff workstation computer (e.g., one of the computers 104-1-n may be dedicated as staff computers at the healthcare facility). For example, prior to initiating the perioperative workflow process 210, the surgeon, anesthesiologist, and other staff are assigned a schedule for their participation through the HIS 202. Using this data, and according to an appropriate rule, the patient workflow process notification system 100 and/or the perioperative notification system 200 will send a message 130 to these caregivers and timely notify them that their participation is needed. For example, one stage of the perioperative workflow process 210 may require an anesthesiologist to administer anesthesia during a specific case at a specific time. Once a particular patient treatment milestone is reached, a production rule will trigger the patient workflow process notification system 100 and/or the perioperative notification system 200 to originate a message 130 to the anesthesiologist in order to notify them that the patient 208 has had his anesthesia assessment is ready for the administration of the anesthesia. Accordingly, the patient workflow process notification system 100 and/or the perioperative notification system 200 may send a message 130 to any one or more of the communication devices 118, the workstation application server 102, the computers 104-1-i, the telephone 128, wherein the message 130 comprises the necessary contact information previously entered and stored in the database 144. As with the patient family 218a messages 130, any time specific information needed for the staff 218b messages 130 is obtained by requesting the patient information 136 from the perioperative workflow process 210.

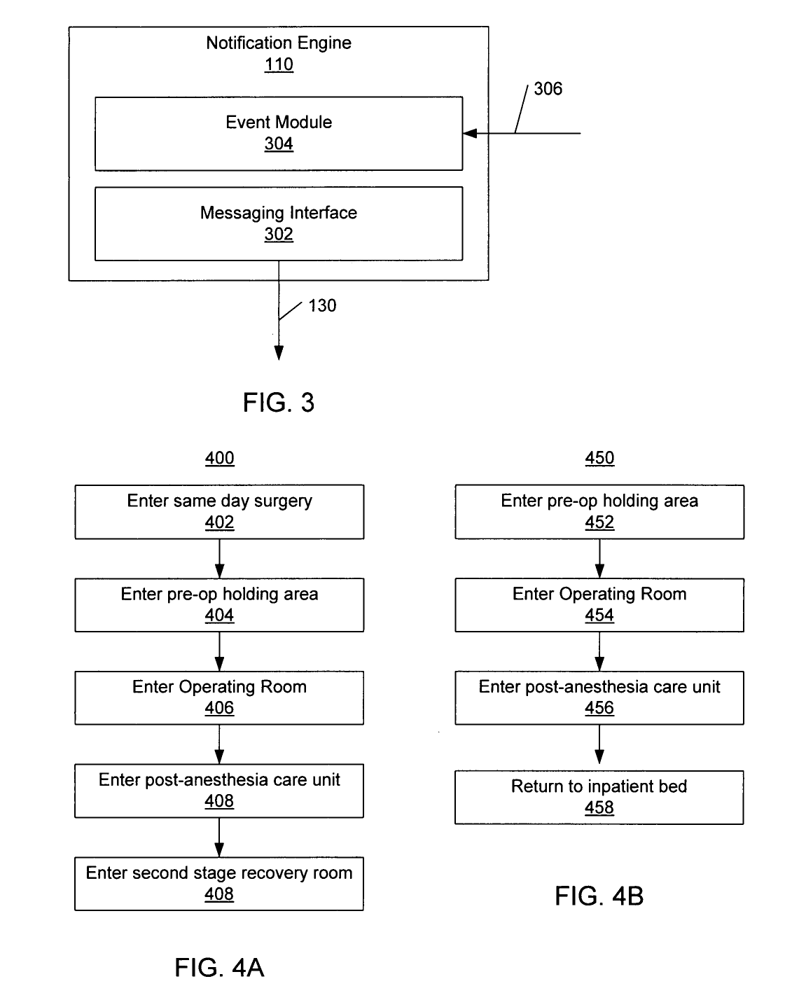

FIG. 3 is a diagram of one embodiment of the notification engine 110 of the PWM system 300. The notification engine 10 may be implemented on the backbone of the patient workflow process notification system 100 and/or the perioperative notification system 200 as illustrated in respective FIGS. 1 and 2, for example. The notification engine 110 comprises a computer based information management system capable of storing, collecting, and processing information concerning the intended treatment flow of the patient 208 through the perioperative process 210. Because the patient workflow process notification system 100 and/or the perioperative notification system 200 store, collect, and process information concerning the status of the patient 208 through the perioperative process, the PWM system 300 may interface with the patient workflow process notification system 100 and/or the perioperative notification system 200 to distribute the information concerning the patient 208.

The notification engine 110 provides a wide scope of communication that includes all the stakeholders 218 (family members 218a and staff 218b). The notification engine 110 defines a generic messaging interface where the diverse number of stakeholders 218 may be treated in a unified manner. The notification engine 110 may deliver the messages 130 in multiple message delivery formats or methods along with a framework where these methods may be seamlessly integrated. The notification engine 110 also may provide automated (event driven) distribution of the messages 130 in addition to providing the messages 130 “on-demand”, where the messages 130 are transmitted based on case event triggers such as time stamps, delays, unmet milestones, and/or schedule updates, among others.

In one embodiment, the notification engine 110 comprises a customizable event module 304. For flexibility, the conditions or business rules that underlie the triggers 306 are not hard-wired to the application logic of the patient workflow process notification system 100 and/or the perioperative notification system 200. The rule-base decision component 108 of the notification engine 110 adapts or extends the event module 304 to meet the demands and needs of the stakeholders 218 and the patient 208 throughout the lifetime of the patient workflow process notification system 100 and/or the perioperative notification system 200. The rule-based decision module 109 operates with production rules. For example, if certain conditions are met for a case event in accordance with the production rules, a predetermined distribution method is activated to deliver the message 130. The conditions may be defined in terms of any data element associated with the case event (e.g., provider, site, procedure, flags) and can be modified as part of the notification templates previously discussed.

The notification engine 110 may employ the rule based decision module 109 to trigger automated notifications for patient-care events that meet previously defined conditional criteria. Through an extensible set of rules, the notification engine 110 determines whether a message 130 should be sent. Once the delivery is approved, the message content, recipients and the communication medium are identified based on the previously defined Notification Templates. The notification engine 110 uses information from the HIS 202, the PWM system 300 and information entered by the family members 218a to make its decisions and build the message 130.

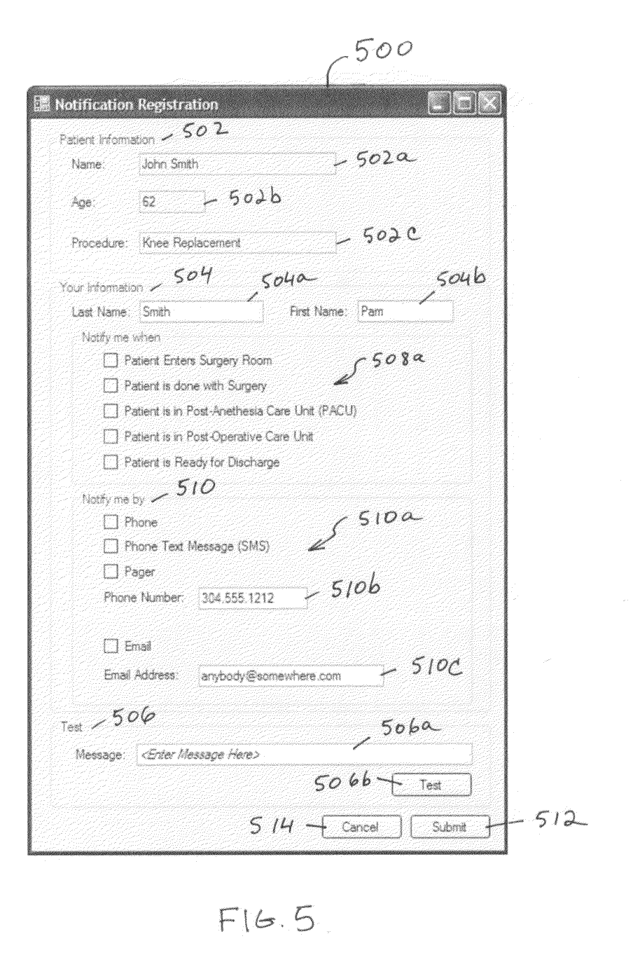

FIG. 4A is a diagram 400 illustrating the stages of one embodiment of the perioperative workflow process 210 for an ambulatory patient 208. An ambulatory 208 patient enters same-day surgery 402. The patient 208 then may enter a pre-op holding area 404. The patient 208 then enters the operating room 406, followed by a post-anesthesia care unit 408 and a second-stage recovery room 410. Optionally, the patient 208 may proceed from the operating room to an intensive care unit 412.

FIG. 4B is a diagram 450 illustrating the stages of one embodiment of the perioperative workflow process 210 for an inpatient 208. An inpatient 208 may enter a pre-op holding area 452. The patient 208 then enters the operating room 454, followed by a post-anesthesia care unit 456. Following the post-anesthesia care unit the patient 208 returns to an inpatient bed 458.

FIG. 5 is an example of a notification registration screen 500 displayed by one embodiment of the notification GUI 134, which presents configurable options to the user. The notification registration screen 500 comprises a patient information portion 502, a user information portion 504 shown as “Your Information” (e.g., a stakeholder 218), and a test portion 506. Once the user enters the desired information in the various portions of the notification screen 500, the user may select the submit button 512 to enter or save the information in the system memory 150 and/or the database 144. Otherwise, the user may select the cancel button 514 to revoke any information entered via the notification screen 500. Via the notification screen 500, the notification GUI 134 presents users with a variety of communication media and communication devices 118 to choose from for purposes of receiving the notification messages 130. For example, the messages 130 may be received at the kiosk computers 104-1-n, the telephone 108, or any of the communications devices 118 such as the laptop or other computer 120 (via email, SMS, or MMS), the pager 122 (numeric or alphanumeric characters via paging protocol, numeric), the cell phone or smart phone 124 (via voice, email, SMS, or MMS), the PDA 126 (via email, SMS, or MMS), or a landline telephone 128 (via voice). This list is not meant to be exclusive, and modifications that enable for additional media are presently contemplated. The default method of notification is to display messages to the end-users (e.g., the stakeholders 218 or recipients) through the waiting room kiosk computers 104-1-n. Accordingly, the notification GUI 134 may require that users explicitly disable the kiosk notification option if they are not interested in that feature.

The patient information portion 502 comprises a name field 502a, age field 502b, and a procedure field 502c with which the user verifies they are accessing the correct patient. The notification GUI 134 may be an application running on any of the computers 104-1-n to display the status of the patient 208 or may be driven by the notification dashboard module 132. The user information portion 504 comprises a last name field 504a and a first name field 504b where the user or the stakeholder 218 may enter their information.

The user information portion 504 comprises a notification event portion 508 where the user can select multiple check boxes 50a depending on the desired notification message 130 triggering event or logical combination of events. In the embodiment illustrated in FIG. 5, the notification message 130 triggering event may be selected in accordance to when: (1) the patient 208 enters the surgery room; (2) the patient 208 is done with surgery; (3) the patient 208 is in the post-anesthesia care unit (PACU); (4) the patient 208 enters the post-operative care unit; and/or (5) the patient 208 is ready for discharge. Others events and/or check boxes may be provided and/or displayed in accordance with other embodiments.

The user information portion 504 also comprises a notification means portion 510 where the user may select from multiple communications devices 118 and communication media. In the embodiment illustrated in FIG. 5, the user may select from multiple checkboxes 510a whether to be notified by way of any one or all of: (1) a telephone (e.g., cell phone or smart phone 124, personal digital assistant 126 [PDA], or a landline telephone 128, 108), phone text message (SMS) (e.g., laptop or other computer 120, cell phone or smart phone 124, personal digital assistant 126 [PDA]), pager (e.g., pager 122), or and/or email (e.g., cell phone or smart phone 124, personal digital assistant 126 [PDA] and/or laptop or other computer 120). If the selected notification means is by way of telephone, the user may enter appropriate telephone number in the phone number field 510b. If the selected notification means is by way of email, the user may enter appropriate email address in the email address field 510c.

The notification registration screen 500 also comprises a test portion 506 where a test message may be entered in a message box 506a. Once a test message is composed, the user may select the test button 506b to transmit the test message by the means selected in the notification means portion 510 of the screen 500.

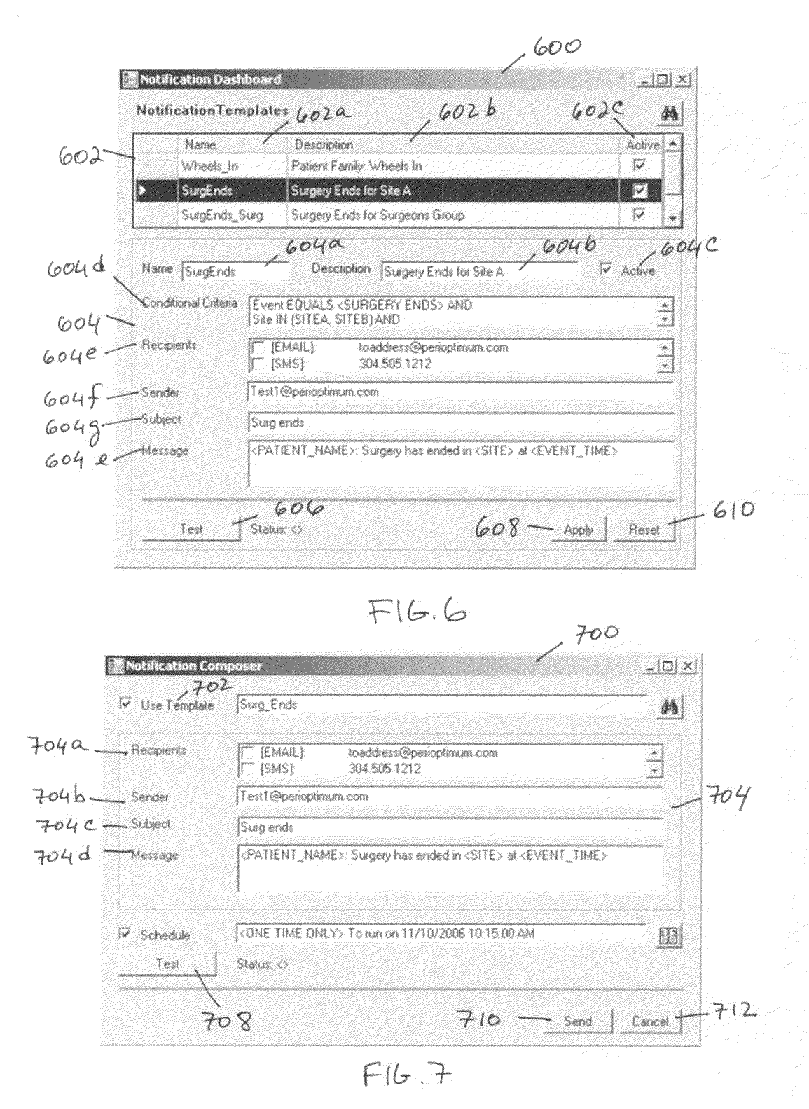

FIG. 6 is an example of one embodiment of a notification template screen 600 displayed by one embodiment of the notification GUI 134. The notification template 600 enables the end users (e.g., stakeholders 218) to author and/or create one or more message notification rules through the use of the pre-defined “Notification Templates”. These custom notification rules may be retransmitted to the PWM system 300 in the notification configuration message 148. The notification template comprises an event selection portion 602 and a notification configuration portion 604. The notification template screen 600 enable the user to: (1) create and modify notification templates; (2) classify/tag notification templates; (3) configure notification logging settings; (4) browse and search persisted notification templates; and (5) instantiate from/test a notification template. The notification template may be created or modified in accordance with the: (1) delivery or communication media (e.g., email, SMS, MMS, paging, telephone, kiosk); (2) content; including data elements from cases/patient/events data-sources+free text+attachments; (3) delivery schedule ((no schedule: event-based, on demand), scheduled to be sent (periodically, one time)); (4) conditional criteria (mapping to rules-base); (5) recipients/CC options; and (6) activation status (active/inactive).

The event selection portion 602 displays one or more events which the stakeholder 218 may select to trigger the transmission of the notification message 130. In the embodiment illustrated in FIG. 6, the event selection portion 602 lists the event by name 602b, description 602, and status 602c. A configuration portion 604 displays the selected event in a name filed 604a and a description of the selected event in a description filed 604b. The status is indicated in a status checkbox 604c. A conditional criteria box 604d box is provided to enable the user to enter the conditional criteria by which the notification message 130 will be triggered. In the illustrated embodiment, the conditional criteria for transmitting the notification message 130 are when the surgery ends and the patient is in site A. This may be expressed as:

Event EQUALS <SURGERY ENDS> AND Site IN (SITEA, SITEB)

A recipient box 604e shows the notification messaging means and the relevant notification contact information for the notification message recipient. The sender is identified in a sender box 604f and the subject of the notification message 130 is provided in a subject box 604g. The content of the notification message 130 is provided in a message box 604g. In the illustrated embodiment, the message content may include:

<PATIENT_NAME>: Surgery has ended in <SITE> at <EVENT_TIME>

The user may send a test message by selecting the test button 606, apply the designated notification template configuration rules by selecting the apply button 608, or simply may reset the template by selecting the reset button 608.

By way of the notification template screen 600 the notification GUI 134 allows the stakeholder 218 to create one or more customized notification templates. The stakeholder 218 can create and modify these templates by entering data into the notification GUI 134. As previously discussed, customization of notification messages 130 is generally directed to: message delivery medium (e.g., email, SMS, MMS, pager, telephone), message content (which may include data elements associated with the patient treatment, as well as plain text and other attachments), the delivery schedule (such as whether the user desires event based messaging or would like to check the patient's progress on-demand), conditional criteria for when messages are to be sent, the recipients of messages (including persons to be carbon copied), and the current status of the notification system (active or inactive), among others, for example. Additionally, the stakeholders 218 can configure the classification or tagging of notification templates for searching or facility administration purposes, as well as define how the notification messages 130 will be logged within the PWM system 300. Users also may be presented with the option to browse and search through archived notification messages 130.

Once the template is created, the notification GUI 134 component enables the stakeholder 218 to test a new notification template by originating a test message. All of the aforementioned options-may not be available to every user. For example, the staff 218b may wish to prevent the family members 218a from having the ability to modify certain configuration settings.

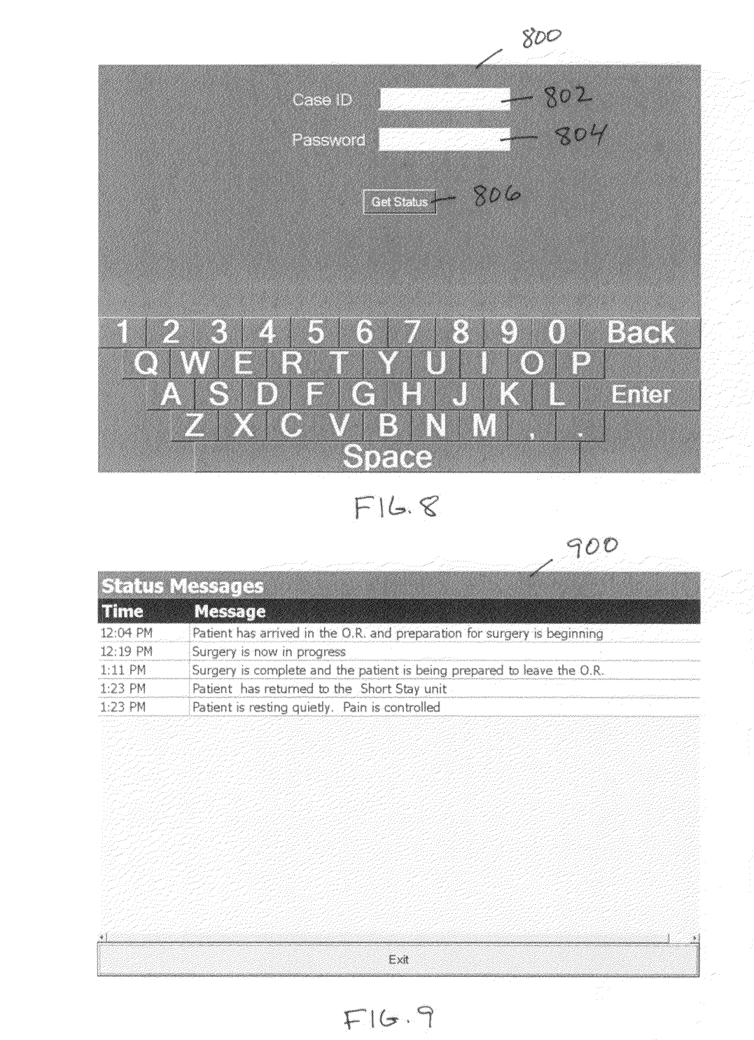

FIG. 7 is an example notification composer screen 700 displayed by one embodiment of the notification GUI. The notification composer screen 700 enables the user to use the notification template shown in the notification template screen 600 in FIG. 6 by selecting the use template checkbox 702. A configuration portion 704 enables the user to compose the desired notification message 130 information in one or more boxes such as the recipient box 704a, the sender box 704b, the subject box 704c, and the message box 704d. A schedule for the transmitting the notification message 130 is provided in a schedule box 706. In the embodiment illustrated in FIG. 7, an on-demand notification message 130 will be transmitted once beginning at a certain date and time as follows:

<ONE TIME ONLY> To run on MM/DD/YY 10:15:00 AM

The user may test the composed message by selecting the send button 708 or may send an on-demand notification message 130 based on the schedule specified in the schedule box 706 by selecting the send button 710. The user may cancel out of the notification composer screen 7000 by selecting the cancel button 712.

FIG. 8 is an example of a login screen 800 as displayed by one embodiment of the notification GUI 134. The stakeholder 218 may enter a case ID 802 and password 804. Selecting the Get Status button 806 enables the stakeholder to view the status of the notification messages 130 that have been transmitted.

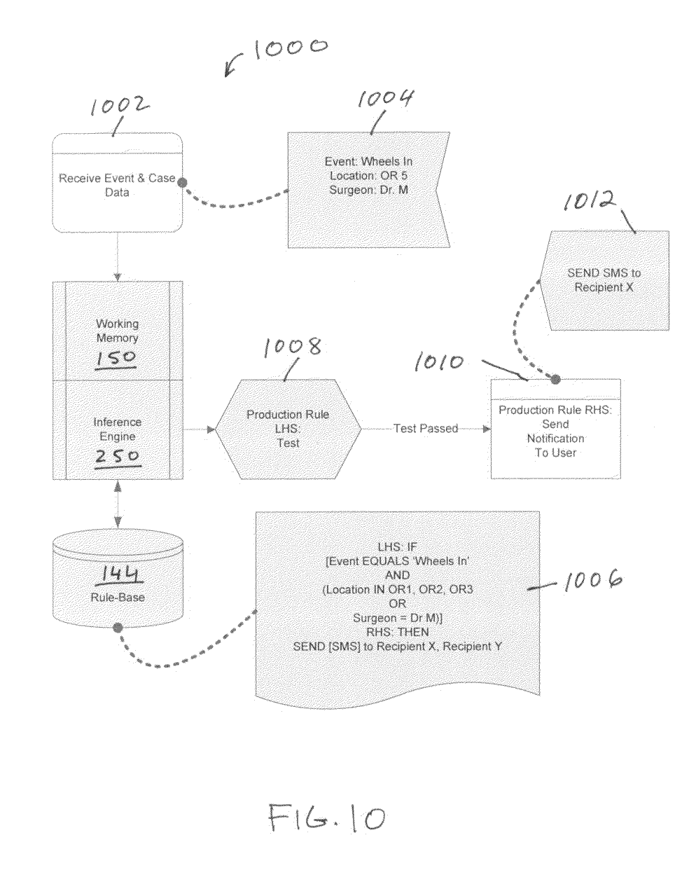

FIG. 9 is an example of notification messages 130 as displayed by one embodiment of the notification GUI 134. These messages may be displayed by the notification GUI 134 when the stakeholder 218 selects the get status button 806 in the login screen 800.

FIG. 10 is a diagram 1000 illustrating a logic of a production rule according to the patient workflow process notification system 100 and/or the perioperative notification system 200 comprising the PWM 300 as described herein. Through the use of production rules, the PWM system 300 determines based on the current patient information 136 whether the message 130 should be sent. Once the decision component determines that the message 130 should be sent, the content of the message 130, recipients, and the communication medium may be selected based on the previously defined notification template 600 in accordance with the custom notification rules. The patient information 136 used by the patient workflow process notification system 100 and/or the perioperative notification system 200 to make decisions is received from the HIS 202, the perioperative workflow process 210, and information entered by the family members 218a. Information from these sources also can be incorporated into each message 130.

In one embodiment, the PWM system 300 creates customizable production rules. The production rules define conditional criteria, and when these criteria are met the PWM system 300 originates the notification message 130 for delivery. Accordingly, the production rules may be created pursuant to the custom notification rules inputted by the family member 218a into the notification GUI 134. For example, the family member 218a may choose to be notified of any delay in the patient procedure by receiving an automated telephone message. The PWM system 300 will then generate a production rule instructing the patient workflow process notification system 100 and/or the perioperative notification system 200 to automatically generate a notification message 130 for the affected stakeholder 218 when it receives the patient information 136 from the perioperative workflow process 210 indicating a delay in the respective patient procedure. These rules are created and stored in the memory 150 portion of the PWM system 300, and are not necessarily hard-wired into the logic of the patient workflow process notification system 100 and/or the perioperative notification system 200. Accordingly, the rules can be deleted or modified, and the PWM system 300 also may be expanded to allow for new conditional criteria and delivery methods without altering the underlying perioperative workflow process 210 or patient workflow process notification system 100 and/or the perioperative notification system 200. Conditions for production rules are defined in terms of any data element associated with an event during the perioperative workflow process 210. They may be modified by users in the same manner as the notification templates described above.

In the embodiment illustrated in FIG. 10, the PWM 300 receives 1002 an event and case data associated with the patient 208. For example, the PWM 300 may receive the patient information 136 specified in box 1004 stating that the patient 208 is being wheeled into operating room number 5 for surgeon Dr. M. The patient information 136 may be stored in the memory 150 and may be accessed by the ProbIE module 250 inference engine. The ProbIE module 25 inference engine retrieves a rule 1006 from the rules database 144 and determines 1008 or tests the patient information 136 received from box 1004 against the retrieved rule 1006. If the rule 1006 passes the test, the PWM 300 determines 1010 to send 1012 the notification message to the recipient (e.g., the stakeholder 218). In the embodiment illustrated in FIG. 10, the rule 1106 is defined as:

IF [Event EQUALS ‘Wheels In’ AND (Location IN OR1, OR2, OR3 OR Surgeon=Dr. M)] THEN SEND [SMS] to Recipient X, Recipient Y

The rule 1006 states that if the event is that the patient is being wheeled into the location of operating room 1, 2, or 3 or if the surgeon is Dr. M, then send the notification message 130 to the recipient. The notification message 130 is an SMS message and the recipients are X and Y.

In various embodiments, the patient workflow process notification system 100 and/or the perioperative notification system 200 may be illustrated and described as comprising several separate functional elements, such as modules. Although certain modules may be described by way of example, it can be appreciated that more or less modules may be used and still fall within the scope of the embodiments. Further, although various embodiments may be described in terms of modules to facilitate description, such modules may be implemented by one or more hardware components (e.g., processors, DSPs, PLDs, ASICs, circuits, registers), software components (e.g., programs, subroutines, logic, application components) and/or combination thereof.

In various embodiments, the patient workflow process notification system 100 and/or the perioperative notification system 200 may comprise multiple modules connected by one or more communications media. Communications media generally may comprise any medium capable of carrying information signals. For example, communications media may comprise wired communications media, wireless communications media, or any combination of both, as desired for a given implementation. Examples of wired communications media may include a wire, cable, printed circuit board (PCB), backplane, semiconductor material, twisted-pair wire, co-axial cable, fiber optics, and so forth. An example of a wireless communications media may include portions of a wireless spectrum, such as the radio-frequency (RF) spectrum. As used herein, communication media also may refer to e-mail, SMS, MMS, paging, telephone, and/or kiosk. The embodiments are not limited in this context.

The modules may comprise, or may be implemented as, one or more systems, sub-systems, devices, components, circuits, logic, programs, or any combination thereof, as desired for a given set of design or performance constraints. For example, the modules may comprise electronic elements fabricated on a substrate. In various implementations, the electronic elements may be fabricated using silicon-based integrated circuit processes such as complementary metal oxide semiconductor (CMOS), bipolar, and bipolar CMOS (BiCMOS) processes, for example. The embodiments are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware, such as a circuit, an application specific integrated circuit (ASIC), Programmable Logic Device (PLD) or digital signal processor (DSP), and so forth. In yet another example, an embodiment may be implemented by any combination of programmed general-purpose computer components and custom hardware components. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled”, however, also may mean that two or more elements are not in direct contact with each other, but yet still co-operate or interact with each other. The embodiments are not limited in this context.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory module. For example, the memory module may include any memory device, memory article, memory medium, storage device, storage article, storage medium and/or storage module, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, various types of Digital Versatile Disk (DVD), a tape, a cassette, or the like. The instructions may include any suitable type of code, such as source code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth. The embodiments are not limited in this context.

While certain features of the embodiments have been illustrated as described herein, many modifications, substitutions, changes and equivalents will now occur to those skilled in the art. It is therefore to be understood that the appended claims are intended to cover all such modifications and variations, as well as any other applicable technologies which may appear in the future, as falling within the true scope of the embodiments.

1. A method of communicating patient workflow process information associated with a patient, the method comprising:
receiving a notification configuration message comprising at least one notification rule, the notification rule comprising conditional tests to determine whether to transmit a notification message, determine the medium for communicating the notification message, and determine a recipient of the notification message;
receiving patient information comprising the state of the patient through a patient workflow process; and
transmitting the notification message comprising the patient information in a communication medium in accordance with the at least one notification rule.

2. The method of claim 1, comprising:
configuring the patient information to include any one of a patient name, care provider, patient location, healthcare facility site, location group, case information, clinical information, event information, and event time.

3. The method of claim 1, comprising:
receiving the patient information substantially in real-time as the patient progresses through the patient workflow process.

4. The method of claim 1, comprising:
determining whether to transmit the notification message automatically in accordance with the occurrence of an event, wherein the notification message is transmitted based on the request.

5. The method of claim 1, comprising:
receiving the notification messages comprising at least one notification rule configured by a stakeholder, wherein the stakeholder is to receive the notification message in accordance with the at least one notification rule.

6. The method of claim 1, comprising:
receiving a plurality of notification messages from a plurality of stakeholders, wherein each of the plurality notification configuration messages comprises at least one notification rule configured by at least one of the plurality of stakeholders, and wherein each one of the plurality of stakeholders is to receive the notification message in accordance with a corresponding at least one notification rule.

7. The method of claim 1, comprising:
receiving the patient information from a real-time location system and from a hospital information system.

8. The method of claim 1, comprising:
transmitting the notification message in a communication medium comprising any one of electronic mail, telephone, cellular telephone, short message service, paging, and multimedia message service.

9. The method of claim 1, wherein the patient workflow process is a perioperative workflow process.

10. The method of claim 1, wherein the patient workflow process is any one of a radiology, oncology, catheterization, and emergency workflow process.

11. A method comprising:
displaying a notification template in a notification dashboard graphical user interface (GUI);
enabling stakeholders to augment, or modify the notification template by way of a data input device;
creating a notification template comprising at least one notification rule configured by the stakeholder, the notification rule comprising conditional tests to determine whether to transmit a notification message, determine the medium for communicating the notification message, and determine a recipient of the notification message; and
transmitting the template configuration message to a patient workflow management messaging system.

12. The method of claim 11, comprising:
receiving message delivery or communication media rules for communicating the notification message selected by the stakeholder into the notification template.

13. The method of claim 11, comprising:
receiving content comprising any one of data elements from a case, a patient, an event, a data-source, free text, and attachments selected by the stakeholder into the notification template.

14. The method of claim 11, comprising:
receiving a notification message delivery schedule selected by the stakeholder into the notification template, wherein the notification message delivery schedule is an automatic periodic delivery schedule.

15. The method of claim 11, comprising:
receiving conditional criteria selected by the stakeholder into the notification template.

16. The method of claim 11, comprising:
receiving at least one recipient of the notification message selected by the stakeholder into the notification template.

17. The method of claim 11, comprising:
receiving a notification message activation status selected by the stakeholder into the notification template.

18. A patient workflow notification system, comprising:
a patient workflow management messaging system comprising a notification engine to receive a notification configuration message comprising at least one notification rule, the notification rule comprising rules to determine whether to transmit a notification message, determine the medium for communicating the notification message, and determine a recipient of the notification message, and to receive patient information comprising the state of the patient through a patient workflow process; and the notification engine to transmit the notification message comprising the patient information in a communication medium in accordance with at least one notification rule.

19. The system of claim 18, wherein the notification engine is to receive the patient information substantially in real-time as the patient progresses through the patient workflow process and is to receive the patient information from a hospital information system.

20. The system of claim 18, comprising:
a rule based decision module to determine whether to transmit the notification message automatically in accordance with the occurrence of an event, wherein the notification message is transmitted based on the request.

21. The system of claim 16, wherein the notification engine is to receive the notification configuration messages comprising at least one custom notification rule selected by a stakeholder, and wherein the notification engine is to transmit the notification message to the stakeholder in accordance with the at least one custom notification rule.

22. The system of claim 18, wherein the notification engine is to receive a plurality of notification configuration messages from a plurality of stakeholders, wherein each of the plurality notification configuration messages comprises at least one custom notification rule selected by at least one of the plurality of stakeholders, and wherein the notification engine is to transmit the notification message to each one of the plurality of stakeholders in accordance with a corresponding at least one custom notification rule.

23. The system of claim 18, wherein the notification engine is to receive the patient information from a real-time location system and from a hospital information system.

24. The system of claim 18, wherein the notification engine is to transmit the notification message in a communication medium comprising any one of electronic mail, telephone, cellular telephone, short message service, paging, and multimedia message service.

25. The system of claim 18, wherein the patient workflow process is a perioperative workflow process.

26. The system of claim 18, wherein the patient workflow process is any one of a radiology, oncology, catheterization, and emergency workflow process.

27. A kiosk computer comprising:
a monitor to display a notification message to be sent on-demand in a notification dashboard graphical user interface (GUI);
a data input device to receive notification rule configurations into the notification template from a stakeholder; and
an application component to create a notification configuration message comprising at least one notification rule selected by the stakeholder, the notification rule comprising rules to determine whether to transmit a notification message, determine the medium for communicating the notification message, and determine a recipient of the notification message, and to transmit the notification configuration message to a patient workflow management system.

28. The kiosk computer of claim 27, wherein the application component is to receive message delivery or communication media rules for communicating the notification message selected by the stakeholder and to update the notification template in accordance therewith.

29. The kiosk computer of claim 27, wherein the application component is to receive content comprising any one of data elements from a case, a patient, an event, a data-source, free text, and attachments selected by the stakeholder and to update the notification template in accordance therewith.

30. The kiosk computer of claim 27, wherein the application component is to receive a notification message delivery schedule selected by the stakeholder and to update the notification template in accordance therewith, wherein the notification message delivery schedule is an event-based delivery schedule or an automatic periodic delivery schedule.

31. The kiosk computer of claim 27, wherein the application component is to receive conditional criteria selected by the stakeholder and to update the notification template in accordance therewith.

32. The kiosk computer of claim 27, wherein the application component is to receive at least one recipient of the notification message selected by the stakeholder and to update the notification template in accordance therewith.

33. The kiosk computer of claim 27, wherein the application component is to receive a notification message activation status selected by the stakeholder and to update the notification template in accordance therewith.

34. The kiosk computer of claim 27, wherein the patient workflow management system is a perioperative workflow management system.

35. The kiosk computer of claim 27, wherein the patient workflow management system is any one of a radiology, oncology, catheterization, and emergency workflow process management systems.

36. An article comprising a machine-readable storage medium containing instructions that if executed enable a system to receive a notification configuration message comprising at least one notification rule, the notification rule comprising conditional tests to determine whether to transmit a notification message, determine the medium for communicating the notification message, and determine a recipient of the notification message; receive patient information comprising the state of the patient through a patient workflow process; and transmit the notification message comprising the patient information in a communication medium in accordance with the at least one notification rule.

37. The article of claim 36 comprising instructions that if executed enable the system to configure the patient information to include any one of a patient name, care provider, patient location, healthcare facility site, location group, case information, clinical information, event information, and event time.

38. The article of claim 36 comprising instructions that if executed enable the system to receive the patient data substantially in real-time as the patient progresses through the patient workflow process.

39. The article of claim 36 comprising instructions that if executed enable the system to determine whether to transmit the notification message automatically in accordance with the occurrence of an event, wherein the notification message is transmitted based on the request.

40. The article of claim 36 comprising instructions that if executed enable the system to receive the notification messages comprising at least one notification rule configured by a stakeholder, wherein the stakeholder is to receive the notification message in accordance with the at least one notification rule.

41. The article of claim 36 comprising instructions that if executed enable the system to receive a plurality of notification messages from a plurality of stakeholders, wherein each of the plurality notification configuration messages comprises at least one notification rule configured by at least one of the plurality of stakeholders, and wherein each one of the plurality of stakeholders is to receive the notification message in accordance with a corresponding at least one notification rule.

42. The article of claim 36 comprising instructions that if executed enable the system to receive the patient information from a real-time location system and from a hospital information system.

43. The article of claim 36 comprising instructions that if executed enable the system to transmit the notification message in a communication medium comprising any one of electronic mail, telephone, cellular telephone, short message service, paging, and multimedia message service.

44. An article comprising a machine-readable storage medium containing instructions that if executed enable a system to display a notification template in a notification dashboard graphical user interface (GUI); enable stakeholders to augment, or modify the notification template by way of a data input device; create a notification template comprising at least one notification rule configured by the stakeholder, the notification rule comprising conditional tests to determine whether to transmit a notification message, determine the medium for communicating the notification message, and determine a recipient of the notification message; and transmit the template configuration message to a patient workflow management messaging system.

45. The article of claim 44 comprising instructions that if executed enable the system to receive message delivery or communication media rules for communicating the notification message selected by the stakeholder into the notification template.

46. The article of claim 44 comprising instructions that if executed enable the system to receive content comprising any one of data elements from a case, a patient, an event, a data-source, free text, and attachments selected by the stakeholder into the notification template.

47. The article of claim 44 comprising instructions that if executed enable the system to receive a notification message delivery schedule selected by the stakeholder into the notification template, wherein the notification message delivery schedule is an automatic periodic delivery schedule.

48. The article of claim 44 comprising instructions that if executed enable the system to receive conditional criteria selected by the stakeholder into the notification template.

49. The article of claim 44 comprising instructions that if executed enable the system to receive at least one recipient of the notification message selected by the stakeholder into the notification template.

50. The article of claim 44 comprising instructions that if executed enable the system to receive a notification message activation status selected by the stakeholder into the notification template.
